(19) United States
(12) Patent Application Publication
(10) Pub. No.: US 2007/0258247 A1
(43) Pub. Date: Nov. 8, 2007

(54) Light-emitting module capable of increasing dispersion diameter

(75) Inventors: Se-Ki Park, Gyeonggi-do (KR); Byung-Choon Yang, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/800,032

(22) Filed: May 2, 2007

(30) Foreign Application Priority Data
May 2, 2006 (KR) 2006-39531

(51) Int. Cl. F21V 5/00

(52) U.S. Cl. 362/326

(57) ABSTRACT

A light-emitting module that allows a display panel to be made thinner is presented. The light-emitting module includes a point-light source and an optical cap. The point-light source is disposed on a substrate. The optical cap surrounds a side portion and an upper portion of the point-light source and has a first embossing pattern formed thereon. Light is emitted from the point-light source and passes through the optical cap to be diffused, for example by the first embossing pattern. Thus, extra components such as a diffusing plate, a diffusing sheet, etc., may be omitted from the display device, and the display device may be slimmer.

### CROSS-REFERENCE TO RELATED APPLICATIONS

This application claims priority to Korean Patent Application No. 2006-39531 filed on May 2, 2006 in the Korean Intellectual Property Office (KIPO), the content of which is herein incorporated by reference in its entirety.

### BACKGROUND OF THE INVENTION

1. Field of the Invention

The present invention relates to a light-emitting module and a display device having the light-emitting module. More particularly, the present invention relates to a light-emitting module capable of increasing a dispersion diameter of an emitted light and a display device having the light-emitting module.

2. Description of the Related Art

Generally, a liquid crystal display (LCD) panel does not emit light. Thus, to operate as a display device, an LCD device typically includes a backlight assembly that provides light to the LCD panel. The backlight assembly includes a light source and an optical unit that enhances the characteristics of the light from the light source before it reaches the LCD panel.

A conventional backlight assembly may be classified as a direct-illumination type backlight assembly and an edge-illumination type backlight assembly. With a direct-illumination type backlight assembly, a plurality of light sources is disposed under an LCD panel. With an edge-illumination type backlight assembly, a light source is disposed at a side of a light-guide plate such that the light generated from the light source enters the light-guide plate through the side and exits through an upper face of the light-guide plate to propagate toward an LCD panel.

A cold cathode fluorescent lamp (CCFL) or a light-emitting diode (LED) is mainly used as the light source. CCFL generates white light with a relatively low temperature, which is similar to natural light. The LED has superior color reproducibility and low power consumption.

Due to LED's advantages of small volume and light weight, it is mainly used in small LCD devices, such as cellular phones, personal digital assistants (PDAs), etc., and other mobile devices. Alternatively, the LED is used as a backlight source of a large size LCD device having a direct illumination type backlight assembly such as a television set.

In the direct illumination type backlight assembly, a red LED, a green LED and a blue LED are disposed, and white light is provided to the LCD panel. The white light is generated by mixing the red light emitted from the red LED, the green light emitted from the green LED and the blue light emitted from the blue LED. Alternatively, in the direct illumination type backlight assembly, a white LED that emits white light is disposed, and the white light is provided to the LCD panel.

The light emitted from the LED has a directional characteristic, so that the emitted light from the LED may be directed toward the front of the LED. Therefore, an optical sheet such as a diffusing plate, a diffusing sheet, etc. may be used in the direct illumination type backlight assembly to improve the uniformity of the light across the surface of the LCD panel. Furthermore, efforts are being made to increase diffusion of the emitted light by changing the shape of an optical lens corresponding to the LED.

As the size of the display device decreases, the number of the optical sheets and a distance interval between the LCD panel and the LED should be decreased. However, due to the light characteristics of the LED, it is difficult to remove the diffusing plate and the diffusing sheet from the direct illumination type backlight assembly. Additionally, it is difficult to decrease the distance interval between the LCD panel and the LED to a predetermined distance interval.

### SUMMARY OF THE INVENTION

The present invention provides a light-emitting module dispersing light that is emitted by a point-light source to increase a dispersion diameter.

The present invention also provides a display device having the above-mentioned light-emitting module.

In one aspect, the present invention is a light-emitting module that includes a point-light source and an optical cap. The point-light source is disposed on a substrate. The optical cap surrounds a side portion and an upper portion of the point-light source. The optical cap has a first embossing pattern formed thereon to diffuse light.

In another aspect, the present invention is a light-emitting module that includes a light-emitting body, an optical lens and an optical cap. The light-emitting body is disposed on a substrate. The optical lens covers the light-emitting body. The optical cap contacts the optical lens and has an internal side surface that makes contact with a surface of the optical lens and an external side surface having an embossing pattern formed thereon.

In still another aspect, the present invention is a display device that includes a power supplying substrate, a light-emitting module and a display panel. The light-emitting module has a plurality of point-light sources that are disposed on the power supplying substrate and an optical cap covering a side surface and an upper surface of each of the point-light sources. The optical cap has an embossing pattern formed on an external upper surface to diffuse light. The display panel is disposed on an upper portion of the light-emitting module.

According to the light-emitting module and the display device of the invention, the optical cap sufficiently diffuses the light that is emitted from the point-light source so that extra components such as a diffusing plate, a diffusing sheet, etc., may be omitted from the display device and the display device may be slimmer.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view illustrating a light-emitting module according to a first exemplary embodiment of the present invention;

FIG. 2 is a cross-sectional view taken along the line I-I′ in FIG. 1;

FIG. 3 is a cross-sectional view illustrating a light-emitting module according to a second exemplary embodiment of the present invention;

FIG. 4 is a cross-sectional view illustrating a dispersion diameter of the emitted light of the light-emitting module in FIG. 3;

FIGS. 5A to 5C are graphs showing a dispersion diameter of the emitted light and a dispersion angle of the emitted light in FIG. 3;

FIG. 6 is a perspective view illustrating a light-emitting module according to a third exemplary embodiment of the present invention;

FIG. 7 is a cross-sectional view illustrating a light-emitting module according to a fourth exemplary embodiment of the present invention;

FIG. 8 is a cross-sectional view illustrating a light-emitting module according to a fifth exemplary embodiment of the present invention;

FIG. 9 is a cross-sectional view illustrating a light-emitting module according to a sixth exemplary embodiment of the present invention;

FIG. 10 is a cross-sectional view illustrating a light-emitting module according to a seventh exemplary embodiment of the present invention;

FIG. 11 is a cross-sectional view illustrating a light-emitting module according to an eighth exemplary embodiment of the present invention; and

FIG. 12 is a cross-sectional view illustrating a display device according to an exemplary embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-sectional illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

### Light-Emitting Module

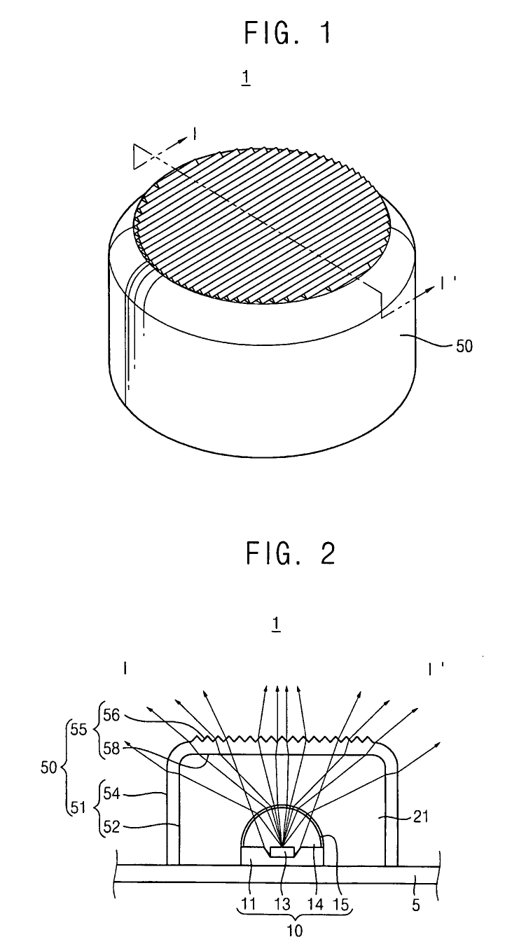

FIG. 1 is a perspective view illustrating a light-emitting module according to a first exemplary embodiment of the present invention. FIG. 2 is a cross-sectional view taken along the line I-I′ in FIG. 1.

Referring to FIGS. 1 and 2, a light-emitting module 1 includes a point-light source 10 and an optical cap 50.

In the present embodiment, the point-light source 10 may include a light-emitting diode (LED). The LED generates minority carriers (electrons or holes) using a p-n junction of a semiconductor, and emits light by re-coupling of the minority carriers. A configuration of the LED may be formed with a plurality of types. When the LED is used in a direct type backlight assembly that is applied in a display device, the LED may be a surface mounted type LED.

In a case of the surface mounted type LED 10, a hole such as a through-hole does not need to be formed on a substrate 5 and the LED 10 is directly mounted on the substrate 5 by soldering, so that high-density mounting of the LED may be relatively easy.

In the present exemplary embodiment, the LED 10 includes an insulation resin case 11, a light-emitting body 13, a protection layer 14 and an optical lens 15.

The insulation resin case 11 is disposed on the substrate 5. An opening portion is formed on the upper surface of the insulation resin case 11, and the light-emitting body 13 is disposed in the opening portion. The light-emitting body 13 may be formed by accumulating a compound semiconductor material having a p-n junction. For example, a first electrode may be formed in a semiconductor having p-type conductivity, and a second electrode may be formed in a semiconductor having n-type conductivity. The first and second electrodes may be formed on the same surface. An external electrode (not shown) providing the light-emitting body 13 with power is formed on the substrate 5. The first and second electrodes are electrically connected to the external electrode through a conductive wire or a conductive paste. The protection layer 14 surrounds the light-emitting body 13 that is exposed through the opening portion, and protects the light-emitting body 13. The optical lens 15 may include a transparent resin, and covers the protection layer 14.

The light-emitting body 13 that is used in the surface-mounted type LED 10 may be selected based on the emitted colors or uses. A semiconductor material of an emitting layer may include GaP, GaAs, GaAsP, AlGaInP, InN, GaN, etc., which is used in the light-emitting body 13. In the display device, an emission wavelength may be selected from the wavelength range of ultraviolet to infrared based on the material of the semiconductor layer. The semiconductor layer may contain more than one material to emit light of a desired wavelength.

The light-emitting body 13 may include a blue LED that emits blue light. To obtain white light, the blue LED may include, for example, a fluorescent material that is a type of transparent resin and emits a yellow color.

When the point-light source 10 is observed squarely from the upper portion of the point-light source 10, the “light-emitting angle” of the point-light source 10 is defined as the maximum angle at which a luminance of light that is observed is greater than or equal to a reference value.

The light-emitting angle of the point-light source 10 changes according to a shape of the point-light source 10, for example, a shape of the opening portion that is formed on the insulation resin case 11, etc. For example, the surface-mounted type LED 10 may have a light-emitting angle of about 60°.

The optical cap 50 diffuses light that is emitted from the point-light source 10. The optical cap 50 includes a polymer resin having superior light transparency, heat resistance, chemical resistance, mechanical strength, etc. Examples of the polymer resin that may be used for the optical cap 50 may include polymethylmethacrylate, polyamide, polyimide, polypropylene, polyurethane, etc. These can be used alone or in combination.

In the present exemplary embodiment, the optical cap 50 is shaped like a cup and surrounds a side surface and the upper surface of the point-light source 10. The optical cap 50 is spaced apart from the point-light source 10. The space between the point-light source 10 and the optical cap 50 may be filled with an air layer 21. An air pressure of the air layer 21 may be equal to atmospheric pressure. In an alternative embodiment, the space between the point-light source 10 and the optical cap 50 may be a vacuum. The optical cap 50 includes a sidewall section 51 and a cover section 55.

The sidewall section 51 includes an internal side surface 52 that surrounds a side surface of the point-light source 10 and an external side surface 54. In the exemplary embodiment, the sidewall section 51 has a cylindrical shape. The cover section 55 is integrally formed with the sidewall section 51 and includes an upper surface 56 and a lower surface 58. The upper surface 56 extends from the external side surface 54. A first embossing pattern is formed on the upper surface 56.

The first embossing pattern includes a prism pattern including rows of prisms as shown in FIGS. 1 and 2. The prism pattern includes a plurality of protrusion parts, each of the protrusion parts having a triangular cross-section and extending in a first direction. A connecting portion that connects the external side surface 54 and the upper surface 56 is curved to transition from the substantially vertical sidewall 51 to the cover 55 that lies generally in a horizontal plane. Similarly, the connecting portion that connects the internal side surface 52 and the lower surface 58 is curved.

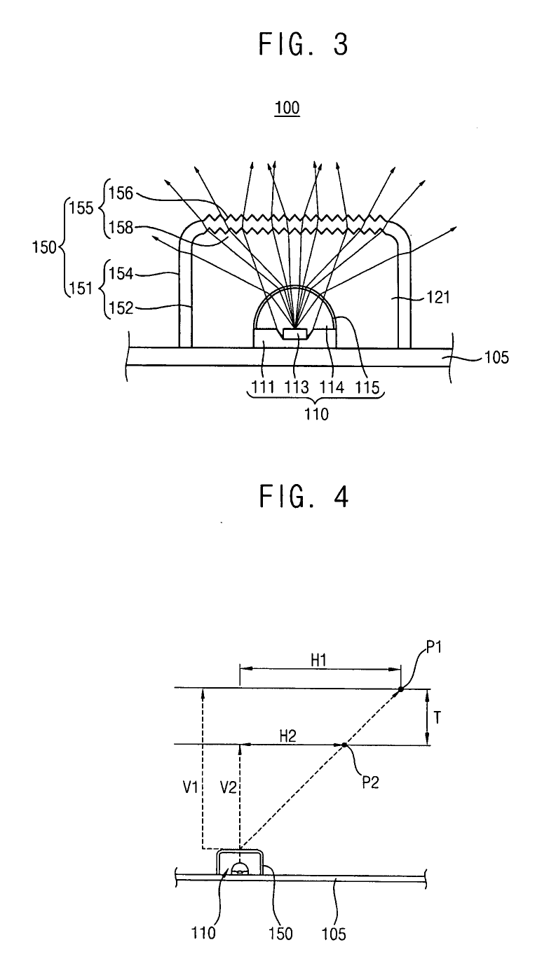

FIG. 3 is a cross-sectional view illustrating a light-emitting module according to a second exemplary embodiment of the present invention.

Referring to FIG. 3, a light-emitting module 100 includes a point-light source 110 and an optical cap 150. The light-emitting module 100 is substantially the same as the light-emitting module 1 in FIGS. 1 and 2 except for the optical cap 150.

Accordingly, the point-light source 110 is mounted on the substrate 105, and the optical cap 150 covers an upper surface and a side surface of the point-light source 110. The optical cap 150 includes a sidewall section 151 and a cover section 155. The optical cap 150 is substantially the same as the optical cap 50 described above in reference to FIGS. 1 and 2.

The cover section 155 includes an upper surface 156 and a lower surface 158. The upper surface 156 extends from an external side surface 154 of the sidewall section 151, and the lower surface 158 extends from an internal side surface 152 of the sidewall section 151.

A first embossing pattern is formed on the upper surface 156, and a second embossing pattern is formed on the lower surface 158. The first and second embossing patterns include a prism pattern having rows of prisms. The prism pattern includes a plurality of protrusions, each of the protrusions having a triangular cross-section and extending in the first direction. The prism type protrusions extend along substantially the same direction and are formed on the upper and lower surfaces 156 and 158.

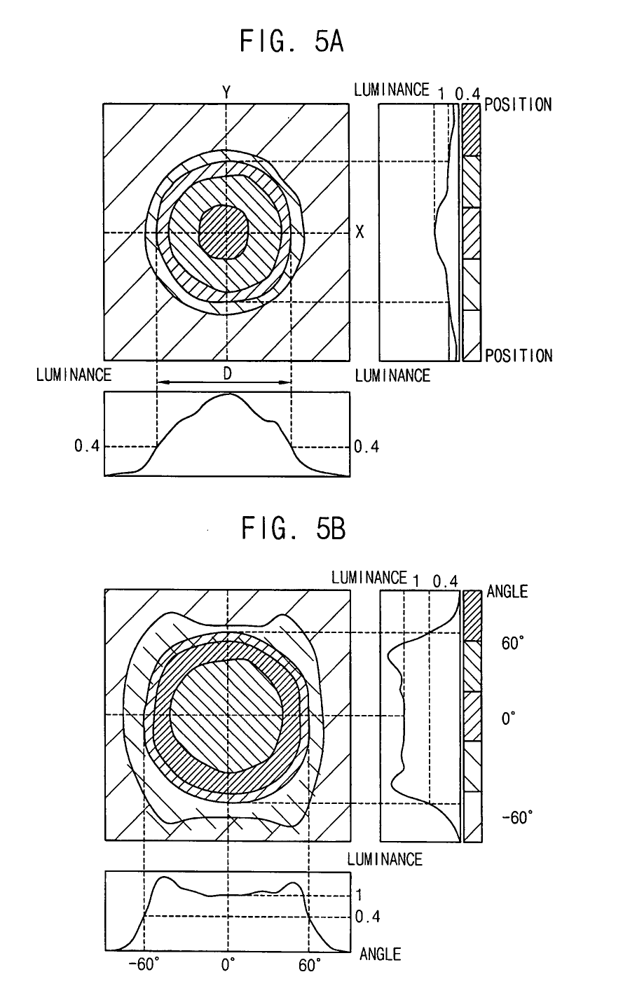

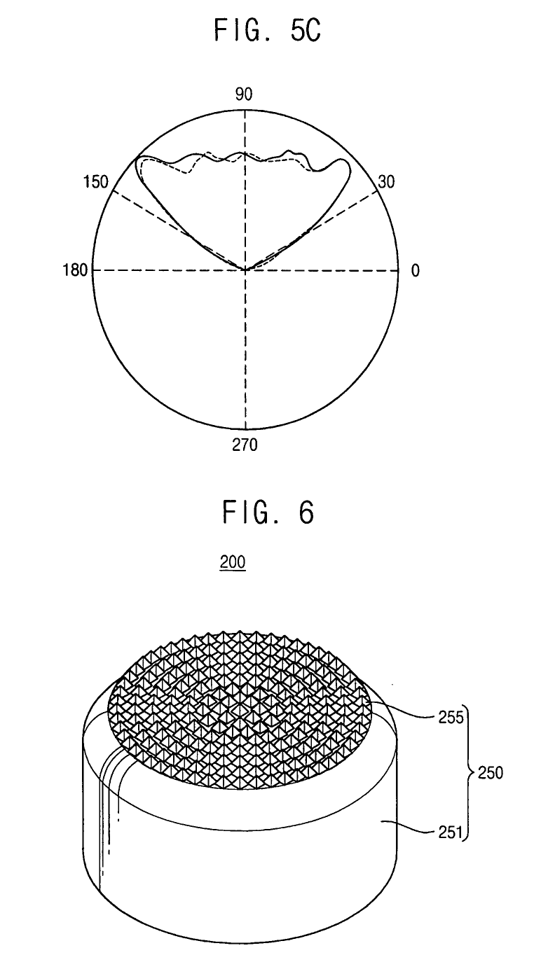

The first embossing pattern on the upper surface 156 has peak portions and valley portions. The peak portions are farthest away from the substrate 105 and the valley portions that lie between the peak portions are closest points to the substrate 105 on the upper surface 156. The second embossing pattern on the lower surface 158 has peak portions and valley portions. On the lower surface 154, the peak portions are farthest away from the substrate 105 and the valley portions are closest to the substrate 105. In the exemplary embodiment, a peak portion of the first embossing pattern is aligned with a valley portion of the second embossing pattern, and a valley portion of the first embossing pattern is aligned with a peak portion of the second embossing pattern. As a result, the cover part 155 has a zigzag cross-section as shown in FIG. 5.

FIG. 4 is a cross-sectional view illustrating a dispersion diameter of the light emitted from the light-emitting module in FIG. 3. FIGS. 5A to 5C are graphs showing a dispersion diameter and a dispersion angle of the emitted light in FIG. 3.

Referring to FIGS. 3 and 4, a “vertical direction” is defined as a direction that is orthogonal to the planar surface of the substrate 105, and a “horizontal direction” is defined as a direction that is perpendicular to the vertical direction.

When the light-emitting module 100 is observed at a first position P1, a dispersion diameter of the emitted light is defined as two times that of a horizontal distance H corresponding to about 40% of the emitted light that is observed at a second position P2. Here, the first position P1 may be spaced apart from the light-emitting module 100 by a first vertical distance V1 and a first horizontal distance H1, and the second position P2 may be spaced apart from the light-emitting module 100 by a second vertical distance V2 and a second horizontal distance H2.

A “beam angle” is defined as two times that of the angle between the vertical direction and a line extending from the point-light source 110 to the first position P1.

A “dispersion ratio” of an emitted light is defined as a light intensity that is observed at the first vertical distance V1 from a total light intensity of the point-light source 110.

Referring to FIG. 3, a light beam can travel in a first path or a second path. A light beam traveling along the first path is emitted from the light-emitting body 113 and refracted three times: at a surface of the optical lens 115, at an internal side surface 152 of the sidewall section 151, and at an external side surface 154 of the sidewall section 151. A light beam traveling along the second path is emitted from the light-emitting body 113 and refracted three times: at a surface of the optical lens 115, at a lower surface 158 of the cover section 155 (or a surface of the second embossing pattern) and at an upper surface 156 of the cover section 155 (or a surface of the first embossing pattern).

As shown in FIG. 3, the light beam that travels along the first path travels along a path that has an increased horizontal distance H1, compared to a case in which the optical cap 150 does not exist. Also, the light beam that travels along the second path is randomly converted by the first embossing pattern and the second embossing pattern. As a result, dispersion is achieved for light that is emitted from the point-light source 110 and propagates in the vertical direction.

FIG. 5A is a graph showing the result of a simulation in which the light-emitting module 100 was observed over a range of distance in the horizontal direction from a vertical direction using Advanced System Analysis Program (ASAP) from Breault Research Organization with input from ZEMAX (Focus Software, Inc.). In FIG. 5A, the axes of the rectangular plots shows the luminance of light as a function of the distance from a central portion of the light-emitting module 100.

Particularly, when the width and the height of the point-light source 110 was about 6 mm and about 2 mm, respectively, each of an internal width, an exterior width and a height of the sidewall portion 151 of the optical cap 150 was about 6 mm, about 8 mm and about 3.5 mm, respectively, and the vertical distance was about 40 mm, the luminance of the light that was emitted from the light-emitting module 100 is shown. Referring to FIG. 5A, the light-emitting module 100 had a dispersion diameter D of the emitted light of about 114 mm and a dispersion ratio of the emitted light of about 76.68%.

FIG. 5B is a graph showing the simulation result of a luminance of the light emitted from the light-emitting module 100 when the light-emitting module 100 was observed over a range of distance in the horizontal direction at an angle by using the ASAP. In FIG. 5B, the axes of the rectangular plots represent the angle between the vertical direction and the observation direction, and the luminance of the emitted light that was observed from the observation direction, respectively.

FIG. 5C is a graph showing the result in FIG. 5B as a function of the observation angle.

Referring to FIGS. 5B and 5C, the beam angle of the light-emitting module 100 was about 120°.

A conventional light-emitting module was simulated using the ASAP. Particularly, the conventional light-emitting module had one point-light source 110 (LED) and a diffusing plate disposed upon the LED 110, such as the LED 110 of an exemplary embodiment of the present invention. The diffusing plate was spaced apart from the LED 110 by about 40 mm, and then the conventional light-emitting module was observed at a vertical direction of the diffusing plate for the simulation. As a result, it was verified that the conventional light-emitting module had a light-dispersion diameter D of about 86 mm, a light-emitting ratio of about 82.38% and a dispersion angle of about 120°.

In comparison with the conventional light-emitting module, the light-emitting ratio of the light-emitting module 100 according to the present exemplary embodiment is about 5.7% lower; however, the light-dispersion diameter of the light-emitting module 100 is about 33% higher and the dispersion angle of the present exemplary embodiment is substantially equal to that of the conventional light-emitting module. The decrease in light-emitting ratio by about 5.7% is not an important factor with respect to optical efficiency of the light-emitting module 100, considering that the light-emitting efficiency of the light-emitting body 113 is enhanced.

The light-dispersion diameter D is preferably large, so as to achieve an optical system having a relatively low number of the light-emitting modules 100 and a slim size. Here, the vertical distance is preferably small.

Referring to FIG. 4, when a first vertical distance V1 from the light-emitting module 100 is about 40 mm, the light-emitting module 100 has a light-dispersion diameter D with a first horizontal distance H1 of about 114 mm. The light-dispersion diameter D of the conventional light-emitting module is about 86 mm. Therefore, when the light-dispersion diameter D is set to a second horizontal distance H2 of about 86 mm in the light-emitting module 100 according to an exemplary embodiment, the second vertical distance V2 is set to be about 30.17 mm from the equation 114/40=86/V2.

Therefore, when the light-dispersion diameter D of the light-emitting module 1 is substantially equal to that of the conventional light-emitting module, the thickness of the optical system may be decreased while maintaining substantially equal efficiency of the light-emitting ratio. That is, in the optical system in FIG. 4, a decrease in thickness T of about 10 mm is achieved.

FIG. 6 is a perspective view illustrating a light-emitting module according to a third exemplary embodiment of the present invention.

Referring to FIG. 6, a light-emitting module 200 includes a point-light source and an optical cap 250. The light-emitting module 200 is substantially the same as the light-emitting module 100 as shown in FIG. 3 except for the optical cap 250.

Therefore, the point-light source is mounted on a substrate, and the optical cap 250 covers an upper surface and a side surface of the point-light source. The optical cap 250 includes a sidewall section 251 and a cover section 255. The optical cap 250 is substantially the same as the optical cap 50 described above in FIGS. 1 and 2 except for the cover section 255. Thus, a first embossing pattern is formed on an upper surface of the cover section 255, and a second embossing pattern is formed on a lower surface of the cover section 255 across the thickness of the cover 55 from the first embossing pattern.

In the exemplary embodiment, the first and second embossing patterns include a pyramid pattern. Therefore, the first and second embossing patterns include a plurality of protrusions, each of the protrusions having a pyramid shape with a peak and a valley. A peak portion is the portion of the pyramid that is farthest away from the substrate and the valley portion is the portion of the pyramid that is closest to the substrate. A peak portion of the first embossing pattern is aligned with a valley portion of the second embossing pattern, and a valley portion of the first embossing pattern is aligned with a peak portion of the second embossing pattern. The plurality of protrusions, each of the protrusions having a pyramid shape, is arranged on the upper surface and the lower surface of the cover section in concentric circles.

In an alternative embodiment, the plurality of protrusions may be arranged in a matrix configuration instead of concentric circles.

FIG. 7 is a cross-sectional view illustrating a light-emitting module according to a fourth exemplary embodiment of the present invention.

Referring to FIG. 7, a light-emitting module 300 includes a point-light source 310 and an optical cap 350. The light-emitting module 300 is substantially the same as the light-emitting module 1 as shown in FIGS. 1 and 2 except for the optical cap 350.

Therefore, the point-light source 310 is mounted on a substrate 305, and the optical cap 350 covers a side surface and an upper surface of the point-light source 310. The optical cap 350 includes a sidewall section 351 and a cover section 355. The optical cap 350 is substantially the same as the optical cap 50 shown in FIGS. 1 and 2, except that the optical cap 350 further includes a light dispersant. Thus, a first embossing pattern that is a prism pattern is formed on an upper surface 356 of the cover section 355.

For example, the light dispersant may be included in the optical cap 350. Alternatively, the light dispersant may be included in an optical layer that is formed on an upper surface of the cover section 355. In the present exemplary embodiment, the light dispersant may be a diffusing bead 359, which may include a high polymer resin having substantially the same index of refraction as the optical cap 350. Alternatively, the diffusing bead 359 may include a high polymer resin having a different index of refraction from that of the optical cap 350.

If the diffusing bead 359 were to be included in the sidewall section 351, light that is emitted from the point-light source 310 that is incident on the sidewall section 351 would be diffused, and the diffused light may travel toward the substrate 305. In this case, the light reaching the substrate 305 decreases light-using efficiency of the light-emitting module 300. Therefore, it is preferable that the diffusing bead 359 be included in the cover section 355 but not in the sidewall section 351 according to the present exemplary embodiment of the present invention.

When the light-emitting module 300 according to the present exemplary embodiment is observed at a vertical distance of about 40 mm using substantially the same simulation method with the ASAP as in FIGS. 5A to 5C, the light-emitting module 300 has a light-dispersion diameter of about 116 mm, a light-dispersion angle of about 117° and a light-emitting ratio of about 71.54%. Therefore, the light-dispersion angle and the light-emitting ratio of the light-emitting module 300 may be slightly lower than that of the light-emitting module 1 shown in FIGS. 1 and 2; however, the light-dispersion diameter of the light-emitting module 300 may be enhanced more than that of the light-emitting module 1 as shown in FIGS. 1 and 2.

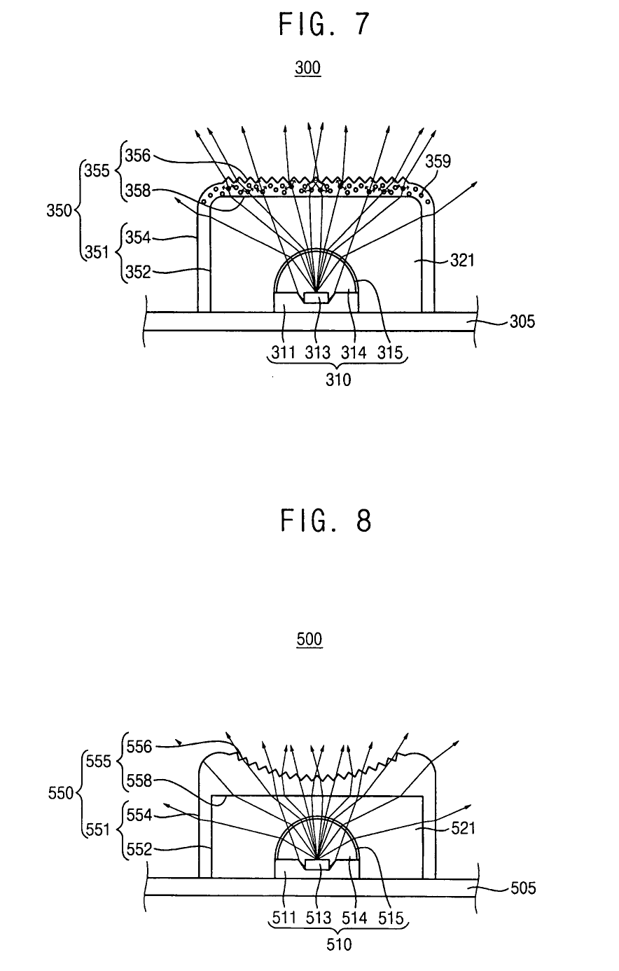

FIG. 8 is a cross-sectional view illustrating a light-emitting module according to a fifth exemplary embodiment of the present invention.

Referring to FIG. 8, a light-emitting module 500 includes a point-light source 510 and an optical cap 550. The light-emitting module 500 is substantially the same as the light-emitting module 1 as shown in FIGS. 1 and 2 except for the optical cap 550. Therefore, the point-light source 510 is mounted on a substrate 505, and the optical cap 550 covers a side surface and an upper surface of the point-light source 510. The optical cap 550 includes a sidewall section 551 and a cover section 555. The optical cap 550 is substantially the same as the optical cap 50 shown in FIGS. 1 and 2, except for the cover section 555.

Therefore, the sidewall section 551 is formed in a cylindrical shape, and includes an internal concave surface 552 and an external concave surface 554 that surround a side surface of the point-light source 510. The cover section 555 includes an upper surface 556 and a lower surface 558. The upper surface 556 extends from the external concave surface 554, and the lower surface 558 extends from the internal surface 552 of the sidewall section 551.

The connecting portion of the external concave surface 554 and the upper surface 556 has a rounded bend, as does the connecting portion of the internal concave surface 552 and the lower surface 558. The lower surface 558 is formed as a relatively flat surface, and the upper surface 556 has a generally concave shape that is closest to the lower surface 558 just above the point-light source 510. That is, the distance between the upper surface 556 and a central portion of the point-light source 510 decreases as the central portion of the point-light source 510 is approached.

A first embossing pattern is formed on the upper surface 556. In some embodiments, the first embossing pattern may be omitted from the upper surface 556 so that the upper surface 556 is smooth, like a concave mirror.

The light that is emitted from the point-light source 510 and incident on the lower surface 558 may be refracted closely to a vertical direction. However, due to the first embossing pattern and the upper surface 556 having a concave shape, the light that reaches the upper surface 556 and the surface of the first embossing pattern is refracted with a horizontal component.

When the light-emitting module 500 according to the present exemplary embodiment is observed at a vertical distance of about 40 mm using substantially the same simulation method with the ASAP as in FIGS. 5A to 5C, the light-emitting module 500 has a light-dispersion diameter of about 115 mm, a light-dispersion angle of about 123° and a light-emitting ratio of about 76.27%. The light-dispersion angle and the light-emitting ratio of the light-emitting module 500 are slightly lower than that of the light-emitting module 1 shown in FIGS. 1 and 2; however, a light-dispersion diameter of the light-emitting module 500 is more enhanced than that of the light-emitting module 1 shown in FIGS. 1 and 2.

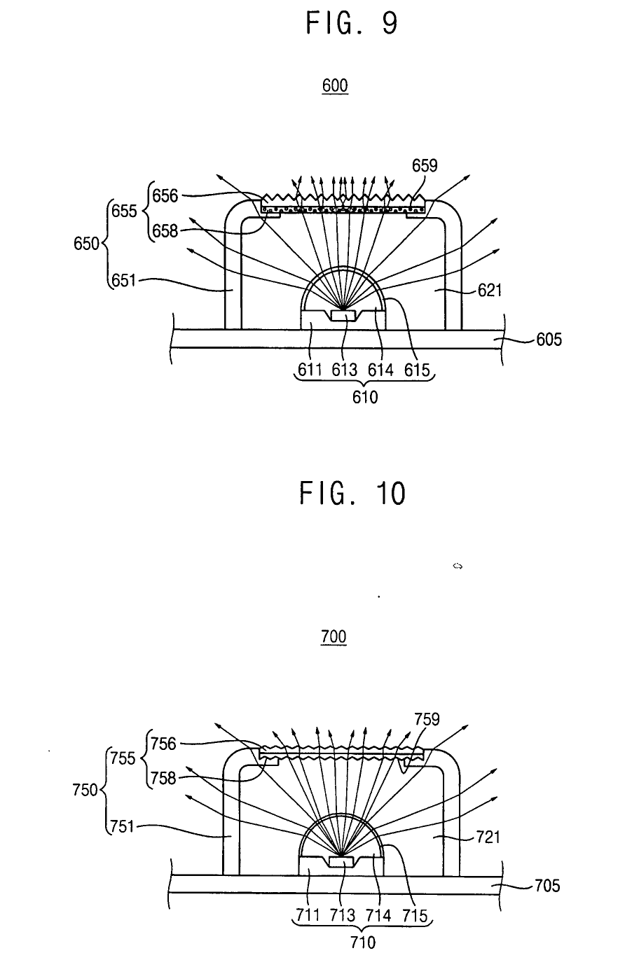

FIG. 9 is a cross-sectional view illustrating a light-emitting module according to a sixth exemplary embodiment of the present invention.

Referring to FIG. 9, a light-emitting module 600 includes a point-light source 610 and an optical cap 650. The light-emitting module 600 is substantially the same as the light-emitting module 1 as shown in FIGS. 1 and 2 except for the optical cap 650.

Thus, the point-light source 610 may be mounted on the substrate 605, and the optical cap 650 may cover an upper surface and a side surface of the point-light source 610. The optical cap 650 may include a sidewall section 651 and a cover section 655. The sidewall section 651 is physically isolated from the cover section 655 different from the optical caps as described above in FIGS. 1 to 8. The sidewall section 651 and the cover section 655 may include, as described above in FIGS. 1 to 8, a polymer resin having superior light transparency, heat resistance, chemical resistance, mechanical strength, etc. The polymer resin may include polymethylmethacrylate, polyamide, polyimide, polypropylene, polyurethane, etc.

The sidewall section 651 surrounds a side surface of the point-light source 610, and has an internal surface and an external surface. The sidewall section 651 has a cylindrical shape. An upper portion of the sidewall section 651 is bent by about ninety degrees. Thus, the bent upper portion of the sidewall section 651 defines an opening portion corresponding to an upper portion of the point-light source 610. A groove (not shown), on which the cover 655 is disposed, is formed on the upper portion of the sidewall section 651.

The cover 655 is disposed on the groove formed on the upper portion of the sidewall section 651, thereby closing the opening portion. The cover 655 includes a first optical layer 656 and a second optical layer 658 formed on a lower surface of the first optical layer 656. A first embossing pattern is formed on an upper surface of the first optical layer 656. The first embossing pattern may include a prism pattern. The second optical layer 658 may include a light dispersant, for example, a diffusing bead 659.

The light incident into the sidewall 651, which is emitted from the point-light source 510, may be refracted and emitted along a path having an increased horizontal distance. The incident light corresponding to the second optical layer 658 may be diffused by the diffusing bead 659, and a path of the emitted light may be changed by the first embossing pattern formed in the first optical layer 656.

When the light-emitting module 600 according to the present exemplary embodiment is observed at a vertical distance of about 40 mm using substantially the same simulation method with the ASAP as in FIGS. 5A to 5C, a light-dispersion diameter, a light-dispersion angle and a light-emitting ratio of the light-emitting module 600 are substantially equal to those of the light-emitting module 1 as shown in FIGS. 1 and 2.

FIG. 10 is a cross-sectional view illustrating a light-emitting module according to a seventh exemplary embodiment of the present invention.

Referring to FIG. 10, a light-emitting module 700 includes a point-light source 710 and an optical cap 750. The light-emitting module 700 is substantially the same as the light-emitting module 600 as shown in FIG. 9 except for the optical cap 750.

Therefore, the point-light source 710 is mounted on a substrate 705, and the optical cap 750 covers a side surface and an upper surface of the point-light source 710. The optical cap 750 includes a sidewall section 751 and a cover section 755. The optical cap 750 is substantially the same as the optical cap 650 shown in FIG. 9, except for the cover section 755.

The cover section 755 includes a first optical layer 756 and a second optical layer 758. The second optical layer 758 is substantially the same as the second optical layer 658 shown in FIG. 9, except that the light dispersant is omitted and the second embossing pattern is formed on the lower surface of the second optical layer 758.

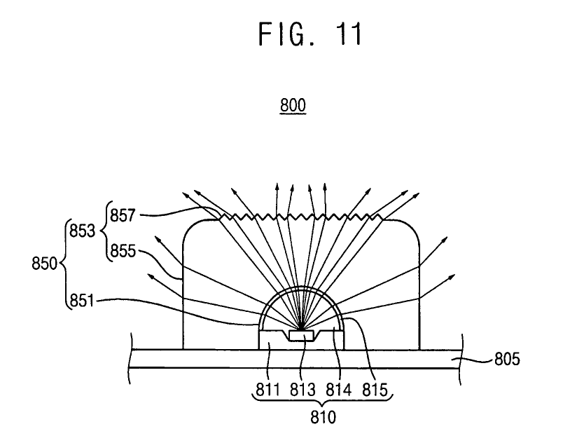

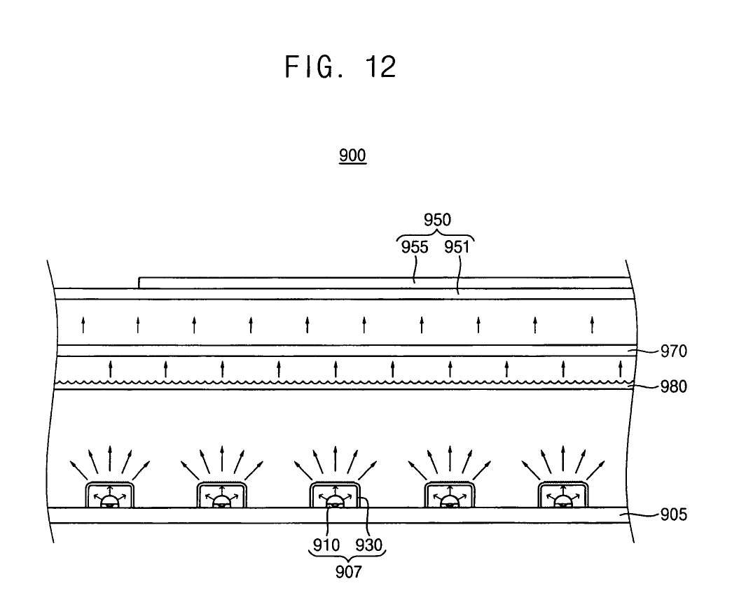

FIG. 11 is a cross-sectional view illustrating a light-emitting module according to an eighth exemplary embodiment of the present invention.

Referring to FIG. 11, a light-emitting module 800 includes an insulation resin case 811, a light-emitting body 813, a protection layer 814, an optical lens 815 and an optical cap 850. The light-emitting body 813 is disposed on a substrate 805, and the protection layer 814 covers the light-emitting body 813. The optical lens 815 covers the protection layer 814.

The optical cap 850 that is integrally formed with the optical lens 815 includes an internal side surface 851 and an external side surface 853. The internal side surface 851 makes contact with a surface of the optical lens 815, and the external side surface 853 includes a side surface 855 and an upper surface 857. The side surface 855 surrounds a peripheral area of the optical lens 815. A first embossing pattern is formed in the upper surface 857 that corresponds to an upper surface of the optical lens 815.

The light-emitting module 800 is substantially the same as the light-emitting module 100 as shown in FIG. 3 except that an air layer is not disposed between the optical cap 850 and the optical lens 815, and the internal surface 851 makes contact with a surface of the optical lens 815.

### Display Device

FIG. 12 is a cross-sectional view illustrating a display device according to an exemplary embodiment of the present invention.

Referring to FIG. 12, a display device 900 includes a power supplying substrate 905, a light-emitting module 907 and a display panel 950. A plurality of external electrodes is formed in the power supplying substrate 905.

The light-emitting module 907 includes a point-light source 910 and an optical cap 930. The point-light source 910 and the optical cap 930 are substantially the same as the point-light source 10 and the optical cap 50 described in FIGS. 1 and 2. Therefore, an electrode of the point-light source 910 is electrically connected to an external electrode that is formed in the power supplying substrate 905.

The display panel 950 displays images based on light that is emitted from the light-emitting module 907. The display panel 950 includes a first substrate 951, a second substrate 955 that faces the first substrate 951 and a liquid crystal layer that is disposed between the first and second substrates 951 and 955. The liquid crystal layer is rearranged by an electric field formed between electrodes that are formed on the first and second substrates 951 and 955. Through the arrangement of the LC molecules, a light intensity that is transmitted by the liquid crystal layer may be controlled.

The display device 900 further includes a luminance-enhancing sheet 970 and a light-condensing sheet 980.

The light-condensing sheet 980 directs light that is emitted from the light-emitting module 907 in a direction that is orthogonal to the surface of the display panel 950. For example, the light-condensing sheet 980 may be a prism sheet having a prism pattern formed thereon. Light that is emitted from the light-condensing sheet 980 may be light that is randomly polarized.

The luminance-enhancing sheet 970 enhances polarization of light that is emitted from the light-condensing sheet 980. For example, the luminance-enhancing sheet 970 may include a dual brightness enhancement film (DBEF) that enhances polarization of randomly polarized light that is emitted from the light-condensing sheet 980. The luminance-enhancing sheet 970 includes a plurality of layers having different refraction indexes from each other. A first direction polarized light of the incident light is refracted and transmitted to the luminance-enhancing sheet 970, and a second direction polarized light of the incident light is reflected by luminance-enhancing sheet 970. Accordingly, the refracting and reflecting are repeated, so that the incident light is reflected and polarized at an interface between the layers.

The display device 900 may further include a first polarization plate and a second polarization plate because the polarizing of the light that is emitted from the luminance-enhancing sheet 970 is not perfect. The first and second polarization plates are disposed at a front face and a rear face of the display panel 950, respectively.

In the display device 900 according to the present exemplary embodiment of the present invention, a light-emitting ratio and a light-dispersion angle of the light-emitting module 907 is relatively equal to that of a conventional light-emitting module that has a point-light source 910, a diffusing plate and a diffusing sheet. Furthermore, a light-dispersion diameter of the light-emitting module 907 is greater than that of the conventional light-emitting module. Therefore, a conventional optical system may adopt a point-light source 910, a diffusing plate, a diffusing sheet, a light-condensing sheet 980 and a luminance-enhancing sheet 970; however, an optical system of the present invention may adopt the light-emitting module 907, a light-condensing sheet 980 and a luminance-enhancing sheet 970 such that the diffusing plate and the diffusing sheet may be omitted.

As described above, in a light-emitting module that has a point-light source and an optical cap that covers the point-light source, the optical cap may enhance optical characteristics of the light that is emitted from the point-light source. For example, a dispersion diameter and a diversion angle of the emitted light may be increased. As a result, the light-emitting module may have a dispersion angle of an emitted light that is relatively equal to that of the conventional optical system having a point-light source, a diffusing plate and a diffusing sheet, and a dispersion diameter of an emitted light that is greater than or equal to that of the conventional optical system. Therefore, an optical sheet such as the diffusing sheet may be omitted. Furthermore, the light-emitting module has a dispersion diameter of an emitted light that is greater than that of the conventional light-emitting module at the same vertical distance. Thus, the vertical distance, that is, a thickness of the optical system, may be decreased compared to the conventional light-emitting module.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light-emitting module comprising:
a point-light source disposed on a substrate; and
an optical cap surrounding a side portion and an upper portion of the point-light source, the optical cap having a first embossing pattern formed thereon to diffuse light.

2. The light-emitting module of claim 1, wherein the optical cap is spaced apart from the point-light source.

3. The light-emitting module of claim 2, wherein the optical cap comprises:
a sidewall part having an internal side surface and an external side surface that surround a side surface of the point-light source; and
a cover part coupled to the sidewall part, the cover part having an upper surface that extends from the external side surface and a lower surface that extends from the internal side surface and that faces the upper surface.

4. The light-emitting module of claim 3, wherein an external connecting portion that transitions the external side surface to an upper surface, and an internal connecting portion that transitions the internal side surface to a lower surface are rounded.

5. The light-emitting module of claim 4, wherein a second embossing pattern is formed on the lower surface.

6. The light-emitting module of claim 5, when a top portion of a protrusion section and a base portion between adjacent protrusion sections are defined as a peak and a valley, respectively, wherein a peak of the first embossing pattern and a valley of the second embossing pattern are aligned with each other, and a valley of the first embossing pattern and a peak of the second embossing pattern are aligned with each other.

7. The light-emitting module of claim 6, wherein each of the first and second embossing patterns comprises a prism pattern.

8. The light-emitting module of claim 4, wherein the first embossing pattern comprises a pyramid pattern.

9. The light-emitting module of claim 4, wherein the optical cap further comprises a light-diffusing agent.

10. The light-emitting module of claim 4, wherein the upper surface is formed in a concave shape that is closest to the point-light source at a position above the point-light source.

11. The light-emitting module of claim 2, wherein the optical cap comprises:
a sidewall part having an internal side surface that surrounds a side surface of the point-light source and an external side surface; and
a cover part disposed on the sidewall section to cover an upper surface of the point-light source, the cover part having the first embossing pattern formed thereon.

12. The light-emitting module of claim 11, wherein the cover comprises:
a first optical layer having the first embossing pattern formed thereon; and
a second optical layer disposed below the first optical layer, the second optical layer diffusing light emitted from the point-light source.

13. The light-emitting module of claim 12, further comprising a second embossing pattern formed on a lower surface of the second optical layer above the point-light source.

14. The light-emitting module of claim 12, wherein the second optical layer comprises a light-diffusing agent.

15. The light-emitting module of claim 2, wherein the point-light source comprises:
a light-emitting body emitting light; and
an optical lens covering the light-emitting body.

16. A light-emitting module comprising:
a light-emitting body disposed on a substrate;
an optical lens that covers the light-emitting body; and
an optical cap contacting the optical lens, the optical cap having an internal side surface that makes contact with a surface of the optical lens and an external side surface having an embossing pattern formed thereon.

17. The light-emitting module of claim 16, wherein the external side surface comprises:
a side surface surrounding the optical lens;
an upper surface connected to the side surface to cover the optical lens, the upper surface having the embossing pattern formed thereon; and
a rounded connecting point that transitions the side surface to the upper surface.

18. A display device comprising:
a power supplying substrate;
a light-emitting module having a plurality of point-light sources that are disposed on the power supplying substrate and an optical cap covering a side surface and an upper surface of each of the point-light sources, the optical cap having an embossing pattern formed on an external upper surface to diffuse light; and
a display panel disposed on an upper portion of the light-emitting module.

19. The display device of claim 18, further comprising:
an optical sheet disposed between the light-emitting module and the display panel.

20. The display device of claim 19, wherein the optical sheet further comprises a luminance-enhancing film that transmits a first direction polarized light and reflects a second direction polarized light perpendicular to the first direction.
